(19) United States
(12) Patent Application Publication
(10) Pub. No.: US 2024/0370852 A1
(43) Pub. Date: Nov. 7, 2024

(54) SYSTEMS AND METHODS FOR PROCESSING, FACILITATING, PROVIDING, OR USING ONLINE CHECKOUT USING A SHARED WALLET ACROSS ISSUERS

(71) Applicant: EARLY WARNING SERVICES, LLC, SCOTTSDALE, AZ (US)

(72) Inventors: Greg Slowiak, Chicago, IL (US); Michael Dempsey, Chicago, IL (US); James Anderson, Kent, CT (US); Matthew Miller, Honolulu, HI (US)

(73) Assignee: EARLY WARNING SERVICES, LLC, SCOTTSDALE, AZ (US)

(21) Appl. No.: 18/398,866

(22) Filed: Dec. 28, 2023

Related U.S. Application Data
(60) Provisional application No. 63/464,440, filed on May 5, 2023.

(51) Int. Cl. G06Q 20/36; G06Q 20/40

(52) U.S. Cl. CPC G06Q 20/3674; G06Q 20/4016; G06Q 20/409

(57) ABSTRACT

A method including receiving a unique identifier for a user. The method also can include determining, using a wallet directory, a shared wallet associated with the unique identifier. The shared wallet can include identifying information for cards issued from multiple different issuers. The method additionally can include sending the identifying information for the cards to enable the user to select one of the cards for a first transaction at a first merchant. The method further can include obtaining information about a first selected card of the cards based on a selection from the user. The method additionally can include requesting a first payment authorization token for the first selected card from a wallet network system. The method further can include sending the first payment authorization token to enable the first merchant to process the first transaction using the first selected card. Other embodiments of related systems and methods are described.

### CROSS-REFERENCE TO RELATED APPLICATION

This application claims the benefit of U.S. Provisional Application No. 63/464,440, filed May 5, 2023. U.S. Provisional Application No. 63/464,440 is incorporated herein by reference in its entirety.

### TECHNICAL FIELD

This disclosure relates generally to processing, facilitating, providing, or using online checkout using a shared wallet across issuers.

### BACKGROUND

Conventional online checkout typically involves a user providing card details to the merchant for the transaction. The merchant often provides the option to store the card information so that the user is not asked for the card information the next time the user does an online checkout at the same merchant. User often have multiple different cards, which are often issued by multiple different card issuers. Additionally, users often use websites of many different merchants, each with their own checkout system.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for processing, facilitating, providing, or using online checkout using a shared wallet across issuers, according to an embodiment; and

FIG. 4 illustrates a flow chart for a method of providing a user interface for processing, facilitating, providing, or using online checkout using a shared wallet across issuers, according to an embodiment.

For simplicity and clarity of illustration, the drawing figures herein illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, two minutes, or five minutes.

### DESCRIPTION OF EXAMPLES OF EMBODIMENTS

Various embodiments include a computer-implemented method. The method can include receiving a unique identifier for a user. The method also can include determining, using a wallet directory, a shared wallet associated with the unique identifier. The shared wallet can include identifying information for cards issued from multiple different issuers. The method additionally can include sending the identifying information for the cards to enable the user to select one of the cards for a first transaction at a first merchant. The method further can include obtaining information about a first selected card of the cards based on a selection from the user. The method additionally can include requesting a first payment authorization token for the first selected card from a wallet network system. The method further can include sending the first payment authorization token to enable the first merchant to process the first transaction using the first selected card.

A number of embodiments include a system including one or more processors and one or more non-transitory computer-readable media storing computing instructions that, when executed on the one or more processors, cause the one or more processors to perform operations. The operations can include receiving a unique identifier for a user. The operations also can include determining, using a wallet directory, a shared wallet associated with the unique identifier. The shared wallet can include identifying information for cards issued from multiple different issuers. The operations additionally can include sending the identifying information for the cards to enable the user to select one of the cards for a first transaction at a first merchant. The operations further can include obtaining information about a first selected card of the cards based on a selection from the user. The operations additionally can include requesting a first payment authorization token for the first selected card from a wallet network system. The operations further can include sending the first payment authorization token to enable the first merchant to process the first transaction using the first selected card.

Further embodiments include one or more non-transitory computer-readable media storing computing instructions that, when executed on the one or more processors, cause the one or more processors to perform operations. The operations can include receiving a unique identifier for a user. The operations also can include determining, using a wallet directory, a shared wallet associated with the unique identifier. The shared wallet can include identifying information for cards issued from multiple different issuers. The operations additionally can include sending the identifying information for the cards to enable the user to select one of the cards for a first transaction at a first merchant. The operations further can include obtaining information about a first selected card of the cards based on a selection from the user. The operations additionally can include requesting a first payment authorization token for the first selected card from a wallet network system. The operations further can include sending the first payment authorization token to enable the first merchant to process the first transaction using the first selected card.

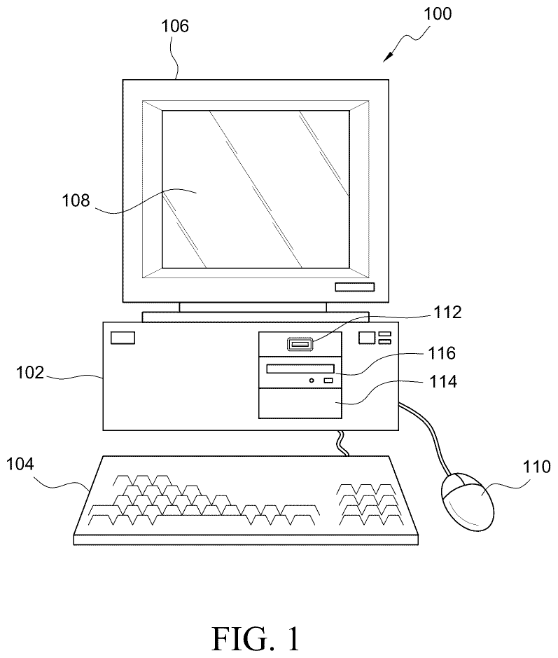

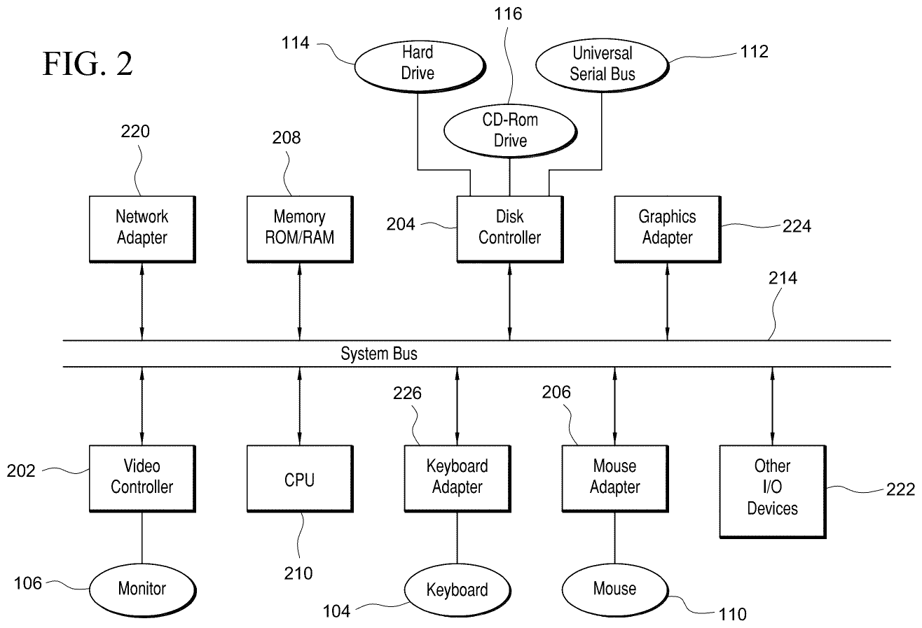

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIGS. 1-2). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) or Field Programmable Gate Arrays (FPGAs) can be programmed to carry out one or more of the systems and procedures described herein. For example, one or more of the programs and/or executable program components described herein can be implemented in one or more ASICs or FPGAs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

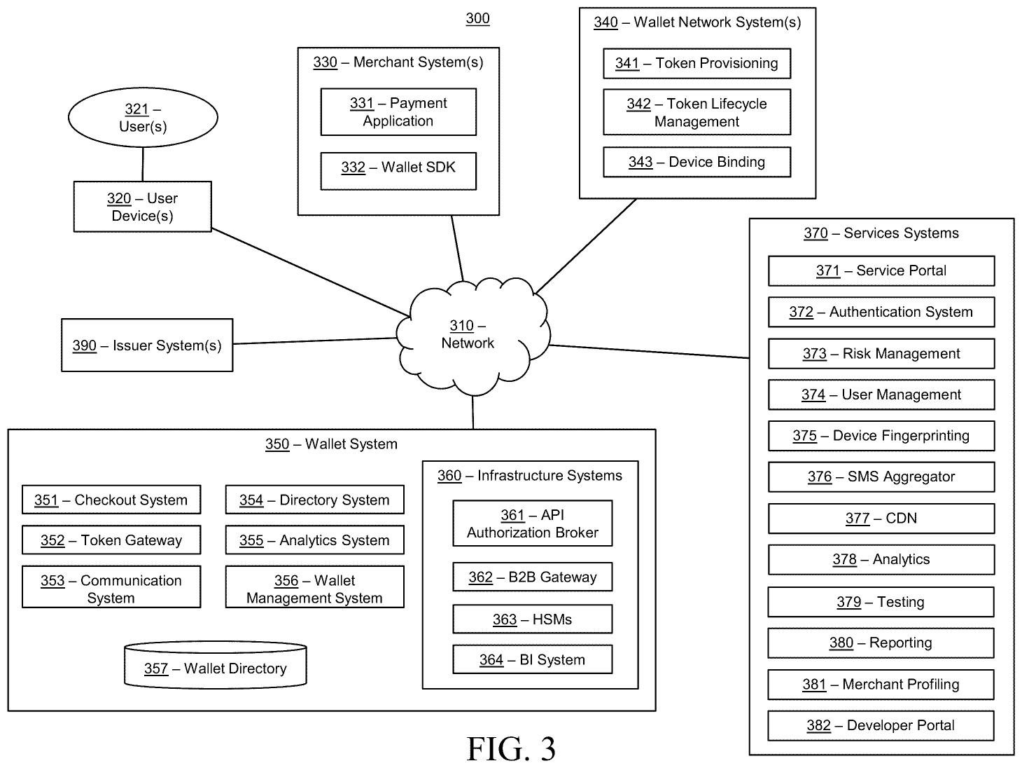

Turning ahead in the drawings, FIG. 3 illustrates a block diagram of a system 300 that can be employed for processing, facilitating, providing, or using online checkout using a shared wallet across issuers, according to an embodiment. System 300 is merely exemplary, and embodiments of the system are not limited to the embodiments presented herein. The system can be employed in many different embodiments or examples not specifically depicted or described herein. In some embodiments, certain elements of system 300 can perform various procedures, processes, and/or activities. In other embodiments, the procedures, processes, and/or activities can be performed by other suitable elements of system 300. Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include various systems, such as one or more user devices 320 used by one or more users 321, one or more merchant systems 330, one or more wallet network systems 340, a wallet system 350, services systems 370, and issuer systems 390 used by issuers. In some embodiments, the systems of system 300 can be in data communication with each other through a network 310. Network 310 can be the Internet or another suitable network, or multiple different networks. In some embodiments, network 310 can be public or private, or can include one or more public networks and one or more private networks.

The systems of system 300, such as user devices 320, merchant systems 330, wallet network systems 340, wallet system 350, services systems 370, and/or issuer systems 390, can each be a computer system, such as computer system 100 (FIG. 1), as described above, and can each be a single computer, a single server, or a cluster or collection of computers or servers, or a cloud of computers or servers. In another embodiment, a single computer system can host multiple systems of system 300. For example, in some embodiments, a single computer system can host wallet system 350 and services systems 370. In some embodiments, wallet system 350 can be provided and/or operated by an entity that is different from the entities operating merchant systems 330, wallet network systems 340, and/or issuer systems 390.

In many embodiments, one or more merchant systems 330 can be operated by one or more merchants or payment service providers, which can host one or more websites and/or application servers. For example, merchant system 330 can host a website, or provide a server that interfaces with an application (e.g., a mobile application), on user device 320, which can allow users 321 (e.g., consumers) to search for items (e.g., products, grocery items), to add items to an electronic cart, and/or to purchase items through an online merchant checkout process, in addition to other suitable activities. These websites or application servers hosted by merchant system 330 can provide a payment application 331 to users 321 using user devices 320. Payment application 331 can provide the online merchant checkout process to user devices 320, to allow user 321 to make a payment.

In a number of embodiments, merchant systems 330 also can run a wallet SDK (software development kit) 332 to enable merchant system 330 provide an online “bank checkout” process to users 321. For example, as part of the online merchant checkout process provided by payment application 331, payment application 331 can launch wallet SDK 332 to provide an online “bank checkout” process to users 321. Wallet SDK 332 can serve user interfaces to the users 321. Wallet SDK 332 can interface with wallet system 350 to obtain wallet services in merchant system 330, which can enable merchant system 330 to provide to users (e.g., 350) an online “bank checkout” process that uses the wallet services. Wallet SDK 332 can be embedded within merchant system 330 to provide merchant system 330 with various functions. For example, wallet SDK 332 can provide user recognition through obtaining or collecting user information from the user, such as an email address of the user. Wallet SDK 332 can send the email address to wallet system 350 to determine the eligibility of the user for using the bank checkout process, such as based on whether there is a wallet for the user in wallet directory 357 with a matching email address. Wallet SDK 332 also can provide one or more user authentication screens, which can allow the user to provide authentication information, such as a one-time passcode (OTP) or multi-factor authentication (MFA). Wallet SDK 332 additionally can provide one or more payment selection screens, which can allow the user to select which payment card to use for the transaction. Wallet SDK 332 further can retrieve payment information from wallet system 350, such as the token cryptogram, to allow the merchant to process the payment using payment application 331. In some embodiments, wallet SDK 332 can interface with one or more services in services systems 370, such as to provide risk management, behavioral analytics, device fingerprinting, and/or other suitable functions. In some embodiments, wallet SDK 332 can obtain device fingerprinting and/or behavioral analytics services through SEON Technologies, WhiteHat Security, Digital Guardian, OneSpan Mobile Authenticator, and/or other suitable services. In the same or other embodiments, wallet SDK 332 can include some of or all of such functionality, and/or other functionality, within wallet SDK 332.

In many embodiments, in addition to communicating with merchant systems 330, wallet system 350 can communicate with other systems, such as wallet network systems 340, services systems 370, and/or issuer systems 390, to provide the wallet services. In many embodiments, the wallet services provided by wallet system 350 can provide a shared wallet for multiple payment cards (e.g., credit cards, debit cards, etc.) that were issued by multiple different issuers (e.g., issuers operating issuer systems 390). In several embodiments, wallet system 350 can provide the wallet services to multiple different merchants (individually or simultaneously), each using a merchant system (e.g., 330).

In certain embodiments, user devices 320 can be desktop computers, laptop computers, mobile devices, and/or other endpoint devices used by one or more users (e.g., user 321). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Lumia® or similar product by the Nokia Corporation of Keilaniemi, Espoo, Finland, and/or (iii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Android™ operating system developed by the Open Handset Alliance, or (iii) the Windows Mobile™ operating system by Microsoft Corp. of Redmond, Washington, United States of America.

In many embodiments, the systems of system 300 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the systems of system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of the system of systems 300. In a similar manner, the processors and/or the non-transitory computer-readable media can be local and/or remote to each other.

Meanwhile, in many embodiments, the systems of system 300 also can be configured to communicate with one or more databases. The one or more databases can include a wallet directory 357, for example, among other databases. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, the systems of system 300, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, merchants operating or employing merchant systems 330 can enroll with the wallet service provided by wallet system 350, so that wallet system 350 can provide wallet SDK 332 or another suitable interface that enables merchant system 330 to interface with wallet system 350 and provide the bank checkout process to users 321. For example, merchant system 330 can run wallet SDK 332 to operate the bank checkout process that uses the shared wallet provided by wallet system 350. Wallet system 350 can create and/or store a wallet for each user (e.g., 321) in wallet directory 357. Wallet directory 357 can include a single shared wallet for a user (e.g., 321) that can be used for multiple different payment cards associated with the user, including multiple cards from different issuers (e.g., issuers operating issuer systems 390). In many embodiments, wallet directory 357 can be centralized, so that it handles payment cards across multiple issuers. In several embodiments, communications between wallet system 350 and issuer systems 390 can occur through wallet network systems 340. The wallet for a user can include information about the payment cards, such as tokenization information for the payment cards, along with other information identifying the user, such as an email address of the user, a phone number of the user, a social security number of the user (or hash thereof). Wallet directory 357 can be pre-populated before the merchant offers the user (e.g., 321) the opportunity to use the bank checkout process that uses the wallet of payment cards associated with the user.

In a number of embodiments, wallet network systems 340 can be operated by wallet network providers, such as payment networks (e.g., Visa, MasterCard, Discover, American Express, etc.). Wallet network system 340 can facilitate transactions between merchants (e.g., merchants operating merchant systems 330) and issuers (e.g., issuers operating issuer systems 390) by providing token services, and also can be referred to as token service providers. In some embodiments, wallet network system 340 can include systems, modules, and/or functions, which can provide the token services. For example, wallet network system 340 can include a token provisioning system 341, a token lifecycle management system 342, and/or a device binding system 343. Token provisioning system 341 can tokenize credentials and/or provision such tokens. Token lifecycle management system 342 can manage the lifecycle of such tokens. Device binding system 343 can enable operating of such tokens in a cloud environment and binding the tokens to devices, such as user devices 320. In some embodiments, wallet network system 340 can provide additional functions (not shown), such as authorization, processing clearing and settlement, processing chargebacks and disputes, etc.

In many embodiments, wallet system 350 can provide the wallet services, such as delivering payment credentials to merchant systems 330. For example, the payment credentials can include a token cryptogram that can be used by merchant system 330 to process the payment using a card in the wallet associated with a user (e.g., 321). In some embodiments, the token cryptogram can be a dynamic payment authorization token. In a number of embodiments, wallet system 350 can include systems, modules, and/or functions, which can perform providing the wallet services and interfacing with other systems (e.g., wallet network systems 340, infrastructure systems 360, services systems 370). For example, wallet system 350 can include a checkout system 351, a token gateway 352, a communication system 353, a directory system 354, an analytics system 355, and/or a wallet management system 356. In a number of embodiments, these systems (e.g., 351-356) of wallet system 350 can provide core wallet services to wallet SDK 332 and interface with other systems (e.g., wallet network systems 340, infrastructure systems 360, services systems 370) to provide such wallet services. In some embodiments, wallet system 350 can include infrastructure systems 360, which can support the systems (e.g., 351-356) of wallet system 350. In other embodiments, infrastructure systems 360 can be outside of wallet system 350. Infrastructure systems 360 are described below in further detail.

In several embodiments, checkout system 351 can interface with wallet SDK 332 in merchant systems 330. For example, checkout system 351 can provide APIs (application programming interfaces) for wallet SDK 332 to interface with wallet system 350, and/or for wallet system 350 to provide the bank checkout process to wallet SDK 332. For example, when a user (e.g., 321) is at a checkout page for the merchant, the functionality and associated data for the bank checkout process can be provided by wallet SDK 332 based on wallet SDK 332 interfacing with checkout system 351 to obtain a list of payment cards in wallet directory 357 and a corresponding purchase payload for a selected payment card to enable payment application 331 of merchant system 330 to process the payment.

In a number of embodiments, token gateway 352 can provide a gateway to interface with wallet network systems 340. In many embodiments, token gateway 352 can provide an abstraction layer to provide a uniform interface experience to the other systems of wallet system 350, such as checkout system 351, despite the different underlying wallet network services provided by wallet network systems 340. For example, Visa Token Service (VTS) and MasterCard Digital Enablement Services (MDES) are different wallet network services that have different interfaces, but token gateway 352 can allow checkout system 351 to communicate with each of these services using the common interface provided by token gateway 352. For example, various systems of wallet system 350 can communicate with wallet network systems 340 to provision cards, such as during auto-enrollment of cards provided by an issuer (e.g., an issuer operating issuer system 390) before the checkout process access by the user (e.g., 321), and/or to obtain a token cryptogram as payment credentials during a payment transaction. In many embodiments, the users can be auto-enrolled based on credentials provided by wallet network systems 340 and/or from issuer systems 390, such as issuer systems 390 communicating to wallet system 350 through wallet network system 340.

In several embodiments, communication system 353 can provide connectivity and/or integration services. For example, communication system 353 can provide connections, interfaces, and/or integration with the systems in infrastructure systems 360 and/or services systems 370, and/or with other systems, such as wallet network systems 340, merchant systems 330, and/or issuer systems 390.

In a number of embodiments, directory system 354 can provide access to and/or maintain the data within wallet directory 357. Wallet directory 357 can be a database that stores wallets for users 321. The wallets can include personal information, such as names, addresses, email addresses, phone numbers (e.g., mobile phone number of a user device (e.g., 320)), social security number (or hash thereof), payment data (e.g., tokenized payment credentials, etc.), bank names of enrolled credentials, an indication of the default payment card for a wallet for a user, whether the user has successfully completed a transaction, the state of the wallet, etc. In some embodiments, wallet directory 357 can be distributed across multiple systems of storage devices. In several embodiments, each wallet in wallet directory 357 can include a wallet identifier or other key that can be used to associate the various elements of the respective wallet. In some embodiments, wallet directory 357 can be completely within wallet system 350. In other embodiments, wallet directory 357 can be outside wallet system 350. In yet other embodiments, wallet directory can be a distributed database that is partially within wallet directory 357 and partially within another system, such as one or more of services systems 370.

In several embodiments, analytics system 355 can aggregate and/or analyze information from checkout transactions. For example, analytics system can generate reports by merchant, such as to determine success or failure rates per merchant, to determine rates of continued use by users after first using through a merchant, and/or to provide other suitable analytics.

In a number of embodiments, wallet management system 356 can provides an interface to directory system 354 from services systems 370, such as a user management system 374 of services system 370. As described below, user management system 374 can allow a user (e.g., 321) to access a portal, such as through a website or a mobile app, to manage the wallet for the user, such as updating consumer profile data, opting out, or other activities. In some embodiments, wallet management system 356 can receive provisioning information from directory system 354.

In a number of embodiments, infrastructure systems 360 can include systems, modules, and/or functions, which can support the systems (e.g., 351-356) of wallet system 350. For example, infrastructure systems 360 can include an API authorization broker 361, a business-to-business (B2B) gateway 362, hardware security modules (HSMs) 363, business intelligence (BI) services 364, and/or other suitable infrastructure services. In many embodiments, API authorization broker 361 can determine a riskiness of API calls made over network 310, such as calls over a public network or the Internet, detecting bots, preventing denial of service attacks, verifying cookies, identifying users, performing device fingerprinting and/or behavior analytics, and/or other functions. In some embodiments, these functions can be provided by Amazon Cognito, Okta, Azure Active Directory, and/or other suitable services.

In many embodiments, B2B gateway 362 can provide a business-to-business authenticated API gateway. In some embodiments, this function can be performed by Amazon API Gateway, Apigee, Azure API Management, IBM API Connect, and/or other suitable services.

In many embodiments, HSMs 363 can be physical devices in a data center used to safeguard and manage cryptographic keys and/or perform cryptographic functions. HSMs 363 can be used to generate dynamic data for payments and protect keys used for data at rest and data in transit. In some embodiments, these services can be provided by Amazon Web Services (AWS) CloudHSM, AWS Key Management Services, Azure Key Vault, and/or other suitable services.

In many embodiments, BI services 364 can provide tools for generating reports and/or dashboards for analytics system 355. In some embodiments, these services can be provided by AWS Tableau, AWS QuickSight, Microsoft Power BI, Looker, and/or other suitable services.

In a number of embodiments, services systems 370 can include systems, modules, and/or functions, which can support wallet SDK 332 and/or the systems of wallet system 350 and/or infrastructure systems 360. These systems, modules, or functions can be part of a single system, or spread across multiple different systems. For example, services systems 370 can include a services portal 371, an authentication system 372, a risk management system 373, a user management system 374, a device fingerprinting system 375, an SMS (Short Message Service) aggregator 376, a CDN (content delivery network) system 377, an analytics system 378, a testing system 379, a reporting system 380, a merchant profiling system 381, a developer portal 382, and/or other suitable systems.

In many embodiments, services portal 371 can provide a portal for merchants and/or issuers to access their accounts with the entity providing wallet system 350 and/or obtain customer service.

In many embodiments, authentication system 372 can authenticate users 321 using user devices 320 when interfacing with wallet SDK 332. For example, authentication system 372 can provide OTP, MFA, and/or other authentication services. In some embodiments, MFA can involve confirming the identity of the user (e.g., 321) using evidence in two or more factors. Factors can include knowledge (e.g., something only the user (e.g., 321) should know, such as passwords, PINs (personal identification numbers), answers to secret questions, etc.), possession (e.g., something only the user (e.g., 321) should have, such as security tokens, etc.), and/or inherence (e.g., something only the user (e.g., 321) is, such as biometric attributes, etc.).

In many embodiments, risk management system 373 can provide fraud and/or risk management services to reliably and/or safely evaluate wallet interactions. For example, risk management system 373 can apply rules, statistical modeling, machine learning, and/or other techniques to various data inputs, such as information about the mobile device, the owner of the mobile device, the payment card account, the owner of the payment card account, the mobile network operator, the token service provider, and/or other suitable information, to determine a risk of fraud or other level of risk. In some embodiments, the output can be a score and/or a decision of whether to allow or reject the provisioning or transaction, and/or to impose further verification procedures. The rules and/or models (e.g., statistical, machine learning, etc.) can use as inputs the data inputs listed above, and/or can be based on blacklists, whitelists, watch lists, velocities (e.g., counts of activities with a common anchor point within a period of time), familiarity (e.g., association with the account or device in the past), integrity (e.g., device malware, crimeware, root, jailbreak), obfuscation (e.g., location spoofing, proxying IP address, spoofing user agent), behavioral patterns, mismatches, anomalies, inconsistencies, and/or other suitable information or rules, or modeling. In some embodiments, a card security code, such as CVV (card verification value), CVV2 (card verification value 2), CVC (card validation code), etc., can be used to authenticate the card as part of the fraud risk determination. Additionally, the user may be asked to verify the ZIP code associated with the card. Further, there may be checks to determine whether the card has been reported lost, stolen, or counterfeit, or for reported fraud or compromise using the card or account.

In many embodiments, different types of risk models can be used with different rules that are relevant to different types of actions attempted by users. In some embodiments, a series of signals can be collected for the risk model from various data sources (e.g., on-device, mobile network operator, in-application history, card association APIs, etc.). In many embodiments, signals can be aggregated and/or translated to be applied into a set of rules (e.g., positive or negative rules) in the risk model. In several embodiments, at a risk moment, risk rules can trigger in the risk model depending on the underlying characteristics of the transaction and/or user behavior/interaction, which result in a risk score. In various embodiments, risk points can be added to the risk score if a negative rule is triggered. In some embodiments, risk points can be subtracted from the risk score if a positive rule is triggered. In several embodiments, risk points can be tallied from each rule and create a total score. In many embodiments, if the score is above a defined threshold (e.g., decline threshold) the attempted action can be declined for potential fraud. In several embodiments, transactional fraud feedback data can subsequently be received, which can be matched into transactions for adjusting/tuning of individual rules to true fraud, and seeding blacklists with risk signals (e.g., mobile devices, IP Addresses, etc.) belonging to fraudsters. In a number of embodiments, the “levers and knobs” of the risk model that allow it to be tuned and/or calibrated for improving possible detection are the set of risk rules included, the risk points/scores/weights, thresholds for each risk rule, and the thresholds for the overall model. The weights can indicate a relative riskiness of an attempted action.

In many embodiments, the decline threshold and/or scores associated with risk rules can be adjusted to tune the risk model based on actual data, such as details of fraud that were not previously caught and the associated risk signals. Some rules can have positive scores, which can correspond to potentially high-risk situations, and, if triggered, can increase the risk score. Other rules can have negative scores, which can correspond to low-risk situations, and, if triggered, can decrease the risk score. As an example, an attempted action (e.g., transaction, provisioning, etc.) can generate a number of risk signals, which can be positive and/or negative. Various rules can be triggered, which can add or subtract risk points. If the risk score for a provisioning attempt exceeds the decline threshold, card provisioning fraud is likely, and the provisioning can be denied. In other embodiments, the provisioning attempt can be further investigated.

In several embodiments, risk rule tuning can be contingent on receiving “ground truth” fraud feedback data, such as issuer-contributed fraud performance data. In many embodiments, statistical measures of effectiveness can be used to consider adjustments to rule weighting (e.g., rule points/rule scores) within the model based on one or more of the following factors, for example: coverage (considering the percentage of total transactions flagged by the rule), detection (considering the percentage of total fraudulent transactions flagged by the rule, or the percentage of total fraudulent dollars flagged by the rule), hit rate (considering the percentage of flagged transactions that were actually fraudulent), lift (considering how much better a rule does when compared to random selection, such as based on detection divided by coverage), false positive rate (considering the proportion of good users tagged as bad by model), false negative rate (considering the proportion of bad users tagged as good by model), and/or other suitable factors. In many embodiments, customized risk rules can be created based on specific feedback data. For example, blacklist risk rules can be developed based on specific fraud risk signals used in the past.

In many embodiments, user management system 374 can allow users 321 to access a portal, such as through a website or a mobile app, to manage the wallet for the user. For example, the user can update consumer profile data, opt out, or perform other activities. In some embodiments, user management system 374 can interface with wallet system 350 through wallet management system 356, a described above.

In many embodiments, device fingerprinting system 375 can provide device fingerprinting and/or behavioral analytics services, which can be used to collect device and/or browser-related data to identify a specific device (e.g., user device 320) connected to network 310 (e.g., the Internet) and/or to provide a device identifier. The device identifier can be used by risk management system 373 to determine risk scores for the device. In some embodiments, device fingerprinting system 375 can be performed through SEON Technologies, WhiteHat Security, Digital Guardian, OneSpan Mobile Authenticator, and/or other suitable services.

In many embodiments, SMS aggregator system 376 can be an SMS aggregator and/or gateway system used to aggregate and deliver SMS messages to user devices (e.g., 320) via mobile network operators. These SMS messages can be used for sending the OTP authentication messages, among other messages. In some embodiments, SMS aggregator system 376 can be performed through Twilio, MessageBird, Podium, and/or other suitable services.

In many embodiments, CDN system 377 can provide a geographically distributed, networked system for fast delivery of internet content. In some embodiments, CDN system 377 also can provide protection against distributed denial of service (DDOS) attacks. In some embodiments, CDN system 377 can be performed through Akamai, AWS, Lumen, and/or other suitable services.

In many embodiments, analytics system 378 can be used to track and/or report website traffic. In some embodiments, analytics system 378 can be performed through Adobe Analytics, Glassbox, Amplitude Analytics, Semrush, Pendo, and/or other suitable services.

In many embodiments, testing system 379 can provide testing services, such as A-B split testing to optimize a digital experience. For example, testing system 379 can compare two versions of user interface screens (e.g., checkout screens) against each other to determine which ones performs better or has better market acceptance, but displaying to or more variants of the page to users at random, and performing statistical analysis to determine which variation performs better for a given conversion goal. In some embodiments, testing system 379 can be performed through AB Tasty, VWO Testing, Split, Salesforce Marketing Cloud Personalization, and/or other suitable services.

In many embodiments, reporting system 380 can provide reporting services based on wallet transactions, such as transactions through wallet network systems 340. These reports can be provided on regularly set intervals or on an ad-hoc basis.

In many embodiments, merchant profiling system 381 can be used to onboard and manage merchants for participating in the bank checkout process using wallet system 350. In some embodiments, merchant profiling system 381 can perform KYC (know your client) services and/or other compliance checks to determine whether or not the merchant is valid and is not participating in fraudulent activity. In a number of embodiments, merchant profiling system 381 can be accessed through an API or a portal. For example, in some embodiments, merchants can be onboarded through the API or the portal, and once onboarded, the profile for the merchant can be managed through the portal. The profile can include merchant information, such as merchant name, DBA (doing business as) name, URL (uniform resource locator), address, contact details etc. The profile also can be used to determine the capabilities of the merchant and the preferences of the merchant for enabling the checkout experience, to determine whether the merchant is a basic eCommerce merchant or is also a token requestor (e.g., for Credential on File tokens), and/or whether the merchant will provide the keys to secure the communication and access to wallet system 350.

In many embodiments, developer portal 382 can be used by developers interfacing with the systems or components thereof of system 300 to obtain development and/or API information, perform sandbox testing, and/or other development activities.

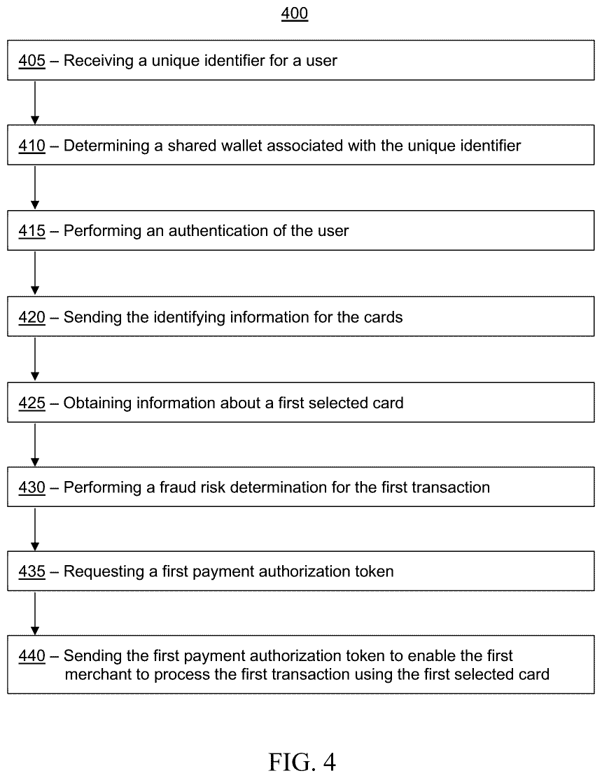

Turning ahead in the drawings, FIG. 4 illustrates a flow chart for a method 400 of processing, facilitating, providing, or using online checkout using a shared wallet across issuers, according to an embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3), wallet system 350 (FIG. 3), and/or services system 370 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of system 300 (FIG. 3), wallet system 350 (FIG. 3), and/or services system 370 (FIG. 3). The processor(s) can be similar or identical to the processor(s) described above with respect to computer system 100 (FIG. 1). In some embodiments, method 400 and other activities in method 400 can include using a distributed network including distributed memory architecture to perform the associated activity. This distributed architecture can reduce the impact on the network and system resources to reduce congestion in bottlenecks while still allowing data to be accessible from a central location.

Referring to FIG. 4, method 400 can include an activity 405 of receiving a unique identifier for a user. The user can be similar or identical to user 321 (FIG. 3). In some embodiments, the unique identifier can be an email address of the user, such as an email address entered by the user through payment application 331 (FIG. 3) or wallet SDK 332 (FIG. 3). In other embodiments, the unique identifier can be another suitable unique identifier, such as a phone number.

In several embodiments, method 400 also can include an activity 410 of determining, using a wallet directory, a shared wallet associated with the unique identifier. The wallet director can be similar or identical to wallet directory 357 (FIG. 3). The shared wallet can include identifying information for cards issued from multiple different issuers. The issuers can be associated with issuer systems (e.g., 390 (FIG. 3). In some embodiments, the cards can be preloaded into the shared wallet before a transaction (such as the first transaction described below) based on the cards being provisioned in the shared wallet based at least in part on information provided from the multiple different issuers. In some embodiments, each of the cards can be provisioned in the shared wallet based at least in part on an acceptable outcome of a respective fraud risk determination for provisioning each of the cards. In some embodiments, the shared wallet further can include an email address of the user, a phone number of the user, a hash of a social security number of the user, and/or other suitable information.

In a number of embodiments, method 400 further can include an activity 415 of performing an authentication of the user. In some embodiments, activity 415 of performing the authentication of the user can include causing a multi-factor authentication to be performed based at least in part on using a phone number of a mobile device of the user. In other embodiments, other suitable authentication procedures can be performed by wallet system 350 (FIG. 3), authentication system 372 (FIG. 3), wallet network system 340 (FIG. 3), and/or issuer system 390 (FIG. 3), as described above.

In several embodiments, method 400 additionally can include an activity 420 of sending the identifying information for the cards to enable the user to select one of the cards for a first transaction at a first merchant. For example, the first transaction can be an online checkout at the first merchant, which can be an online merchant. In some embodiments, the identifier information for the cards can be sent to wallet SDK 332 (FIG. 3) to be displayed on a user interface on user device 320 (FIG. 3) to the user (e.g., 321 (FIG. 3)).

In a number of embodiments, method 400 further can include an activity 425 of obtaining information about a first selected card of the cards based on a selection from the user. For example, the user can select one of the cards displayed to the user through wallet SDK 332 (FIG. 3).

In several embodiments, method 400 additionally can include an activity 430 of performing a fraud risk determination for the first transaction with the first selected card. In several embodiments, the fraud risk determination can be performed by wallet system 350 (FIG. 3), authentication system 372 (FIG. 3), wallet network system 340 (FIG. 3), and/or issuer system 390 (FIG. 3), as described above. In some embodiments, activity 430 of performing the fraud risk determination can include causing one or more fraud risk determinations to be performed by one or more third-party systems, and the performing the fraud risk determination for the first transaction based in part on the one or more fraud risk determinations. In some embodiments, the one or more fraud risk determinations can be performed by the wallet network system. In some embodiments, the one or more fraud risk determinations can be based at least in part on a card security code for the first selected card, as described above. In some embodiments, the one or more fraud risk determinations can be based at least in part on a device fingerprinting for a mobile device of the user, as described above. In some embodiments, the one or more fraud risk determinations can be based at least in part on behavior analytics of the user, as described above. In some embodiments, the fraud risk determination can be based at least in part on one or more of rules, one or more statistical models, and/or or one or more machine-learning models, as described above. In some embodiments, the fraud risk determination can be based at least in part on inputs comprising registered owner information for a mobile device of the user, registered owner information for the first selected card, and/or other suitable information, such as described above.

In a number of embodiments, method 400 further can include an activity 435 of requesting a first payment authorization token for the first selected card from a wallet network system. For example, wallet system 350 (FIG. 3) can request the first payment authorization token from wallet network system 340 (FIG. 3) for the first transaction.

In several embodiments, method 400 additionally can include an activity 440 of sending the first payment authorization token to enable the first merchant to process the first transaction using the first selected card. In some embodiments, the first payment authorization token can include a dynamic payment authorization token, such as an authorization token that is different from each transaction. In some embodiments, the first payment authorization token can include a token cryptogram.

In several embodiments, one or more of the activities of method 400 can be performed for a second transaction, such as a second transaction using a second selected card at a second merchant. For example, at the second merchant, the user can enter the email address of the user, and activity 405 can involve receiving such email address, such as at wallet system 350. Activity 410 can similarly determine the shared wallet associated with the unique identifier, after which activity 415 can involve performing an authentication of the user, and activity 420 can involve sending identifying information for the cards to enable the user to make a selection for the second transaction at the second merchant. Activity 425 can involve obtaining the second selected card, and activity 430 can involve performing a fraud risk determination for the second transaction. Activity 435 can involve requesting a second payment authorization token, and sending the second payment authorization token to enable the second merchant to process the second transaction using the second selected card.

Although systems and methods for processing, facilitating, providing, or using online checkout using a shared wallet across issuers has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that any element of FIGS. 1-4 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders. As another example, the components within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A computer-implemented method comprising:
receiving a unique identifier for a user;
determining, using a wallet directory, a shared wallet associated with the unique identifier, wherein the shared wallet comprises identifying information for cards issued from multiple different issuers;
sending the identifying information for the cards to enable the user to select one of the cards for a first transaction at a first merchant;
obtaining information about a first selected card of the cards based on a selection from the user;
requesting a first payment authorization token for the first selected card from a wallet network system; and
sending the first payment authorization token to enable the first merchant to process the first transaction using the first selected card.

2. The computer-implemented method of claim 1, wherein the first payment authorization token comprises a dynamic payment authorization token.

3. The computer-implemented method of claim 1, wherein the first payment authorization token comprises a token cryptogram.

4. The computer-implemented method of claim 1, wherein the cards are preloaded into the shared wallet before the first transaction based on the cards being provisioned in the shared wallet based at least in part on information provided from the multiple different issuers.

5. The computer-implemented method of claim 1, wherein each of the cards are provisioned in the shared wallet based at least in part on an acceptable outcome of a respective fraud risk determination for provisioning each of the cards.

6. The computer-implemented method of claim 1, wherein the shared wallet further comprises an email address of the user and a phone number of the user.

7. The computer-implemented method of claim 1, wherein the shared wallet further comprises a hash of a social security number of the user.

8. The computer-implemented method of claim 1 further comprising:
sending the identifying information for the cards to enable the user to select one of the cards for a second transaction at a second merchant different from the first merchant;
obtaining information about a second selected card of the cards based on a selection from the user;
requesting a second payment authorization token for the second selected card from the wallet network system; and
sending the second payment authorization token to enable the second merchant to process the second transaction using the second selected card.

9. The computer-implemented method of claim 1 further comprising:
performing an authentication of the user.

10. The computer-implemented method of claim 9, wherein performing the authentication of the user further comprises:
causing a multi-factor authentication to be performed based at least in part on using a phone number of a mobile device of the user.

11. The computer-implemented method of claim 1 further comprising:
performing a fraud risk determination for the first transaction with the first selected card.

12. The computer-implemented method of claim 11, wherein performing the fraud risk determination further comprises:
causing one or more fraud risk determinations to be performed by one or more third-party systems; and
performing the fraud risk determination for the first transaction based in part on the one or more fraud risk determinations.

13. The computer-implemented method of claim 12, wherein the one or more fraud risk determinations is performed by the wallet network system

14. The computer-implemented method of claim 12, wherein the one or more fraud risk determinations is based at least in part on a card security code for the first selected card.

15. The computer-implemented method of claim 12, wherein the one or more fraud risk determinations is based at least in part on a device fingerprinting for a mobile device of the user.

16. The computer-implemented method of claim 12, wherein the one or more fraud risk determinations is based at least in part on behavior analytics of the user.

17. The computer-implemented method of claim 11, wherein the fraud risk determination is based at least in part on one or more of rules, one or more statistical models, or one or more machine-learning models.

18. The computer-implemented method of claim 11, wherein the fraud risk determination is based at least in part on inputs comprising registered owner information for a mobile device of the user and registered owner information for the first selected card.

19. A system comprising one or more processors and one or more non-transitory computer-readable media storing computing instructions that, when executed on the one or more processors, cause the one or more processors to perform operations comprising:
receiving a unique identifier for a user;
determining, using a wallet directory, a shared wallet associated with the unique identifier, wherein the shared wallet comprises identifying information for cards issued from multiple different issuers;
providing the identifying information for the cards to enable the user to select one of the cards for a first transaction at a first merchant;
obtaining information about a first selected card of the cards based on a selection from the user;
requesting a first payment authorization token for the first selected card from a wallet network system; and
sending the first payment authorization token to enable the first merchant to process the first transaction using the first selected card.

20. One or more non-transitory computer-readable media storing computing instructions that, when executed on one or more processors, cause the one or more processors to perform operations comprising:
receiving a unique identifier for a user;
determining, using a wallet directory, a shared wallet associated with the unique identifier, wherein the shared wallet comprises identifying information for cards issued from multiple different issuers;
providing the identifying information for the cards to enable the user to select one of the cards for a first transaction at a first merchant;
obtaining information about a first selected card of the cards based on a selection from the user;
requesting a first payment authorization token for the first selected card from a wallet network system; and
sending the first payment authorization token to enable the first merchant to process the first transaction using the first selected card.
